(19) United States
(12) Patent Application Publication
(10) Pub. No.: US 2018/0099622 A1
(43) Pub. Date: Apr. 12, 2018

(54) INTEGRATED HANGER CASE FOR MOBILE DEVICE

(71) Applicant: Perry Richardson, Los Gatos, CA (US)

(72) Inventor: Perry Richardson, Los Gatos, CA (US)

(21) Appl. No.: 15/729,387

(22) Filed: Oct. 10, 2017

Related U.S. Application Data
(60) Provisional application No. 62/496,276, filed on Oct. 11, 2016.

(51) Int. Cl. B60R 11/02; B65D 73/00; H04R 1/02

(52) U.S. Cl. CPC B60R 11/0241; B60R 2011/0033; H04R 1/02; B65D 73/0064

(57) ABSTRACT

An integrated hanger case configured to hold a mobile device. The integrated hanger case comprises an integrated hanging feature comprising a hook, and a case portion comprising a rear panel and a side wall forming a perimeter around said rear panel. The integrated hanging feature is attached to the case portion and can be in a retracted position inside the case portion or in an extended position partially outside the case portion. When the hook of the integrated hanging device is outside the case portion, it may be used to hang the integrated hanger case, and thus the mobile device installed in it, from an article of choice.

This application claims the priority benefit of U.S. Provisional Application No. 62/496,276, filed Oct. 11, 2016.

### TECHNICAL FIELD

The presently disclosed subject matter relates to a case for a mobile device comprising a hanging mechanism.

### BACKGROUND

Mobile devices are integrated in every aspect of modern life and are extensively used for communication, socialization, entertainment and work. There are many types of mobile electronic devices including cellular phones, pagers, tablet computers and music players. Typically these devices are battery powered, so that people can carry and use them during their daily lives (e.g., on a bus, train or car, at the gym, riding a bike, etc.).

Since mobile devices are very prominent in daily life, there is a need to use them hands-free, so that one can use both hands for other purposes. Current mobile devices cases are mostly designed to be held in one's hand, or to lay flat on a surface. Some cases allow the user to lean the mobile device on a stand comprised in the case, but that still requires a suitable flat surface. Other solutions comprise various mobile device mounts, but those are area specific and cannot be used in versatile environments.

The present subject matter discloses a mobile device case which is suitable for hands-free use in dynamic and changing environments. The presently disclosed integrated hanger case allows users to easily hang their mobile device from any available article, such as bicycle handle bar, handbag strap or a car mirror, and thus free their hands. In addition, the integrated hanger case allows a user to hang a mobile device in a desired orientation for optimal quality audio or video communications, while having the freedom to use both hands.

The present invention provides a lightweight, removable, low cost, easy to manufacture, easy to ship, easy to transport, easy to store and easy to use mobile device case which answers a growing need in the field.

### SUMMARY

In one embodiment, the presently disclosed subject matter provides an integrated hanger case comprising: an integrated hanging feature comprising a hook, and a case portion configured to hold the integrated hanging feature and a mobile device. The case portion comprises a rear panel, and a side wall forming a perimeter around the rear panel. The side wall comprises a lip positioned at the top of the side wall. A portion of the side wall comprises a longitudinal protrusion into the interior of the case portion, wherein the protrusion is positioned at the bottom of said portion of side wall. The longitudinal protrusion and the lip are configured to securely retain the mobile device between them. A gap exists between the mobile device and the inner surface of the rear panel when the mobile device is installed in the case portion. The gap is configured to hold the integrated hanging feature when said feature is in a retracted position, or to hold a portion of the integrated hanging feature when said feature is in an extended or partially extended position.

In some embodiments, the rear panel comprises at least one opening usable for the operation of the mobile device when said mobile device is installed in the case portion.

In some embodiments, the side wall comprises at least one opening and at least one button feature usable for the operation of the mobile device when said mobile device is installed in the case portion.

In some embodiments, the rear panel comprises a pivot pin.

In some embodiments, the integrated hanging feature is attached to the pivot pin and rotates around said pivot pin.

In some embodiments, the case portion comprises an opening between a portion of the side wall and the rear panel and wherein the opening facilitates the rotation of the integrated hanging feature to a position in which said integrated hanging feature is partially outside the case portion.

In some embodiments, the integrated hanging feature is fully retracted and is positioned inside the case portion.

In some embodiments, the integrated hanging feature rotates to an extended position, wherein in said position the hook is outside the case portion, enabling a user to hang the integrated hanger case.

In some embodiments, the case portion comprises an opening between a portion of the side wall and the rear panel, wherein the opening facilitates sliding the integrated hanging feature into a position in which said integrated hanging feature is partially outside the case portion.

In some embodiments, the rear panel comprises an opening used to contact the integrated hanging feature and slide said integrated hanging feature to a position in which said integrated hanging feature is partially outside the case portion. In some embodiments, said opening is big enough for a user to contact the integrated hanging device with the user's finger or fingers.

In some embodiments, the integrated hanging feature comprises an edge wherein said edge is thicker than the opening between a portion of the side wall and the rear panel, thus preventing the integrated hanging feature from detaching from the case portion.

In some embodiments, the integrated hanging feature is fully retracted and is positioned inside the case portion.

In some embodiments, the integrated hanging feature slides to an extended position wherein the hook is outside the case portion, enabling a user to hang the integrated hanger case.

### BRIEF DESCRIPTION OF THE DRAWINGS

FIG. 1 illustrates the use of the integrated hanger case as means of hanging a cell phone from car mirror.

FIG. 2 illustrates a perspective view of a mobile device installed in the integrated hanger case, wherein the integrated hanging feature is fully extended.

FIG. 3 illustrates a perspective view of a mobile device installed in the integrated hanger case, wherein the integrated hanging feature is retracted.

FIG. 4 illustrates a perspective view of the integrated hanger case, wherein the integrated hanging feature is extended.

FIG. 5 illustrates a perspective view of the integrated hanger case, wherein the integrated hanging feature is partially extended.

FIG. 6 illustrates a perspective view of the integrated hanger case, wherein the integrated hanging feature is fully retracted.

FIG. 7 illustrates an embodiment of the integrated hanger case featuring a slide-able integrated hanging feature. The integrated hanging feature is shown in an extended position.

FIG. 8 illustrates an embodiment of the integrated hanger case featuring a slide-able integrated hanging feature. The integrated hanging feature is shown in a retracted position.

FIG. 9 illustrates an embodiment of the integrated hanger case featuring a slide-able integrated hanging feature, showing alternate orientation of the integrated hanging feature.

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

In some embodiments, the presently disclosed subject matter provides an integrated hanger case comprising an integrated hanging feature comprising a hook, and a case portion configured to hold the integrated hanging feature and a mobile device. The case portion comprises a rear panel, and a side wall forming a perimeter around the rear panel.

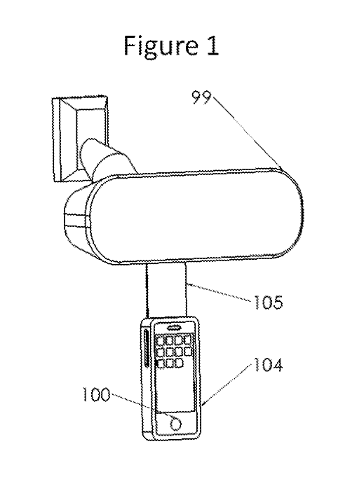

FIG. 1 shows an embodiment of the integrated hanger case 200 wherein a mobile device 100 is installed in the case portion 104 and the integrated hanging feature 105 is in an extended position and attached, via the hook (not shown) to a car mirror 99. Similarly, the integrated hanger case 200 could be used in any environment to position the mobile device by hanging the integrated hanger case 200 enclosing the mobile device from any suitable article and, thus free the user from holding the device in the user's hand. For example, the integrated hanger case 200 could be used by technicians while performing maintenance, or as means of holding a mobile device to take pictures or videos. The dimensions of integrated hanger case 200 may be pre-fabricated to contour a specific mobile device, for example an IPHONE, IPAD, or any other mobile phone or tablet computer, and thus may vary depending on the size of the mobile device.

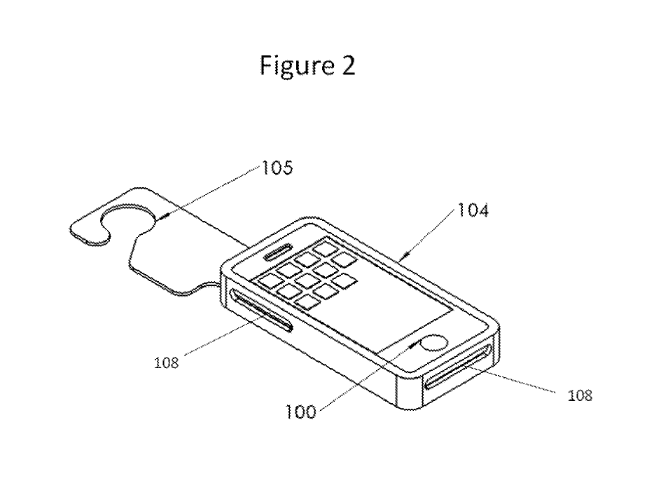

Referring now to FIG. 2, an embodiment of the integrated hanger case 200 is shown, wherein a mobile device 100 is installed in the case portion 104 and the integrated hanging feature 105 is in an extended position. The integrated hanging feature comprises a hook which is used to hang the integrated hanger case 200 from any suitable article. The case portion 104 comprises openings 108 corresponding to features on the mobile device and used to operate features of the installed mobile device. Such features include, for example, the headphone inlet, dock connector, microphone, speakers and vibrate switch.

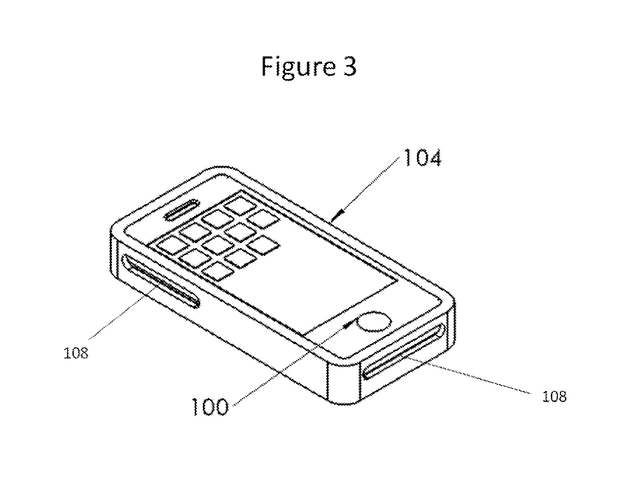

FIG. 3 depicts an embodiment of the integrated hanger case 200 wherein a mobile device 100 is installed in the case portion 104 and the integrated hanging feature 105 is in a fully retracted position. The case portion 104 comprises openings 108 corresponding to features on the mobile device and used to operate features of the mobile device when said device is installed in the case portion 104. The retracted integrated hanging device is held in a gap which exists between the mobile device and the inner surface of the rear panel 113 when the mobile device is installed in the case portion 104.

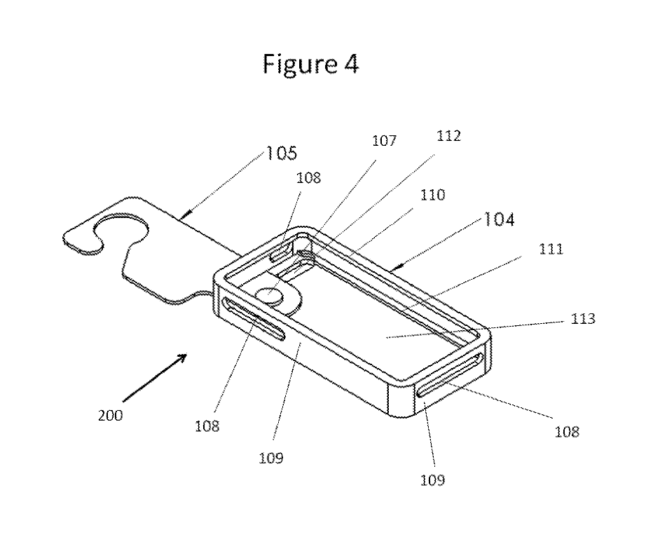

FIG. 4 depicts an embodiment of the integrated hanger case 200 wherein a mobile device 100 is not installed in the case portion 104 and the integrated hanging feature 105 is in an extended position. The side wall 109 comprised in the case portion 104 comprises openings 108 used to operate features of the mobile device when said device is installed in the case portion 104. Similarly, the rear panel 113 comprises at least one opening 112 which correspond to features on the mobile device and allow the user to operate said features when the mobile device 100 is installed in the integrated hanger case 200. Such feature may be, for example, a camera.

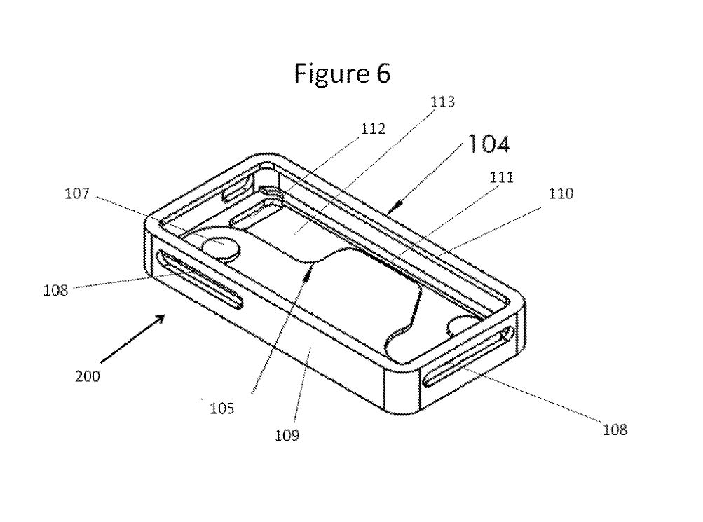

In some embodiments, the side wall comprises at least one button feature (not shown) corresponding to other features on the mobile device such as, but not limited to, volume controls and on/off switches. The button features may be raised and/or molded into the side wall, as thus made of the same material of the side wall. However, in some embodiments the button features may be made of a different material than the side wall, or they may comprise an additional material, such as rubber, to improve tactility and use of the button features. The side wall 109 comprises a lip 110 and a longitudinal protrusion 111. The longitudinal protrusion 111 and the lip 110 are configured to retain the mobile device securely between them and inside the case portion. The rear panel comprises a pivot pin 107 to which the integrated hanging feature 105 is attached. The integrated hanging feature 105 rotates around the pivot pin 107, and thus can be positioned in any desirable position in the range between fully extended (as shown in FIG. 2) and fully retracted (as shown in FIG. 6). The case portion comprises an opening between a portion of the side wall and the rear panel which allows the rotation of the integrated hanging feature 105 to a position in which the integrated hanging feature 105 is partially outside the case portion.

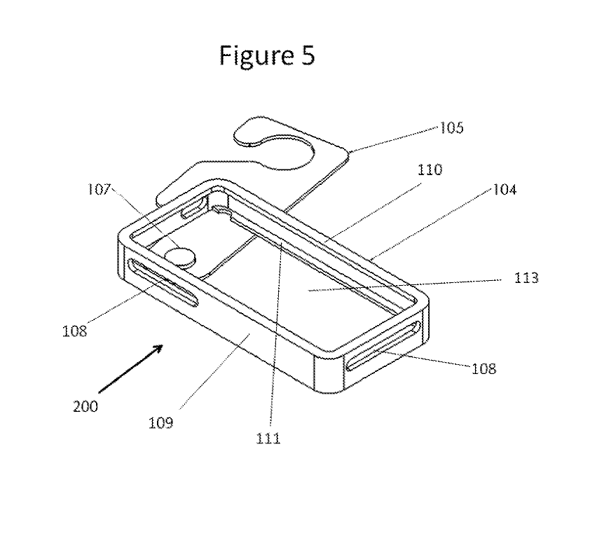

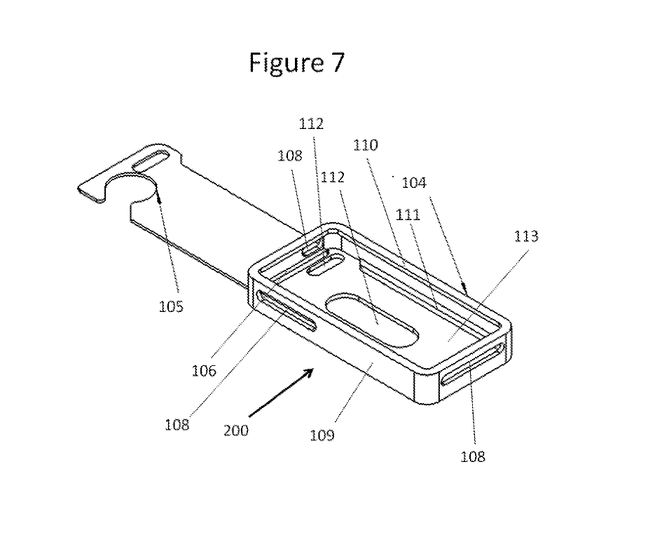

FIG. 5 illustrates an embodiment of the integrated hanger case 104 wherein a mobile device 100 is not installed in the case portion 104 and the integrated hanging feature 105 is in a partially extended position. The rear panel 113 comprises a pivot pin 107 which the integrated hanging feature 105 rotates around. A user can retract or extend the integrated hanging feature 105 by rotating it around the pivot pin 107. The retracted position of the integrated hanging feature 105 allows the user to carry and pack the case without the integrated hanging feature 105 protruding outside the case portion 104, thus allowing for easy storage and transportation. In some embodiments, the embodiment of the integrated hanger case 200 shown in FIGS. 4-6 further comprises an opening 112 in the rear panel 113 which is big enough (as shown in FIG. 7) for a user to contact the integrated hanging feature 105, for example with the user's finger or fingers, and rotate it toward the outside of the integrated hanger case 200 in order to extend the hook feature. Said opening 112 may be big enough for a user to contact it with 1 to 5 fingers, preferably 1 or 2 fingers.

The integrated hanger case 200 may be made of any suitable material, such as, without limitation, plastic or polymeric material. In some embodiments, the integrated hanger case 200 is made of a suitable material such as polycarbonate, polypropylene, polyurethane or polyvinyl. In some embodiments, the different elements of the integrated hanger case are each made of any suitable material or combination of materials such as, but not limited to, plastic, polymeric material, rubber or silicon.

As shown in FIG. 6 the integrated hanging feature 105 is positioned inside the case portion 104 of integrated hanger case 200 when in a fully retracted position. The fully retracted integrated hanging feature 105 does not interfere with the functions and use of the mobile device. For example, the opening 112 in the rear panel 113 is clearly unblocked by the retracted integrated hanging feature 105.

In some embodiments, the integrated hanging feature 105 is extended using a sliding mechanism. FIG. 7 illustrates an embodiment of the integrated hanger case 200 wherein the integrated hanging feature 105 is in an extended position and a mobile device is not installed in the case portion 104. The integrated hanging feature 105 is extended by sliding through an opening between a portion of the side wall 109 and the rear panel 113. The rear panel 113 comprises openings 112 used to facilitate the function and the use of the mobile device and also the extension of the integrated hanging feature 105. In some embodiments, an opening 112 in the rear panel 113 is big enough for a user to contact the integrated hanging feature 105 with the user's finger or fingers, and slide it toward the outside of the integrated hanger case 200 in order to extend the hook feature. In some embodiments, the integrated hanging feature 105 comprises an edge 106 which is thicker than the opening between a portion of the side wall 109 and the rear panel 113, said edge 106 is the farthest from the hook feature of the integrated hanging feature 105, thus allowing the integrated hanging feature 105 to extend fully without detaching from the case portion 104.

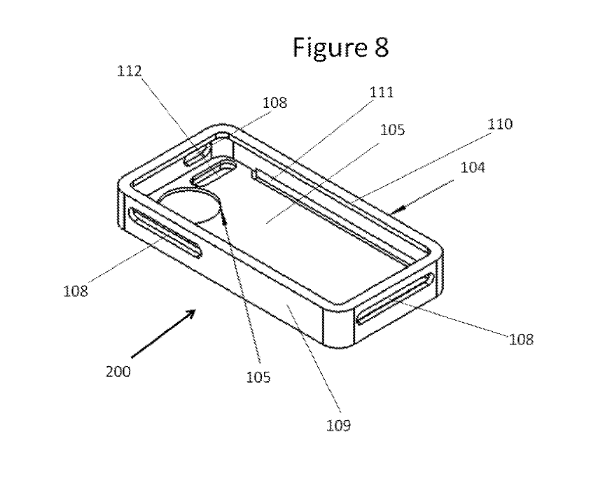

FIG. 8 illustrates the embodiment of the integrated hanger case 200 depicted in FIG. 7 wherein the integrated hanging feature 105 is in a retracted position and a mobile device is not installed in the case portion 104. The fully retracted integrated hanging feature 105 does not interfere with the functions and use of the mobile device. For example, the opening 112 in the rear panel 113 is clearly unblocked by the retracted integrated hanging feature 105.

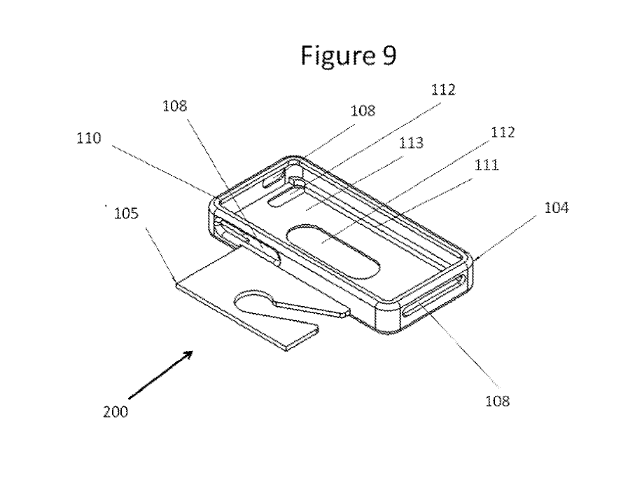

Any side of the integrated hanger case 200 may be configured to facilitate the extension of the integrated hanging feature 105. In the embodiment illustrated in FIG. 9, the integrated hanging feature 105 is extended from the length side of the integrated hanger case 200 and comprises a shorter integrated hanging feature 105, when compared with the integrated hanging feature 105 which extends from the width side of the integrated hanger case 200 (FIG. 8).

1. An integrated hanger case comprising:
an integrated hanging feature comprising a hook; and,
a case portion configured to hold said integrated hanging feature and a mobile device, said case portion comprising:
a rear panel, and a side wall forming a perimeter around said rear panel, said side wall comprising a lip positioned at the top of the side wall;
and a portion of said side wall comprises a longitudinal protrusion into the interior of the case portion, said protrusion positioned the at the bottom of said portion of side wall;
wherein said protrusion and said lip are configured to retain the mobile device between them; and,
wherein a gap exists between the mobile device and the inner surface of the rear panel when the mobile device is installed in the case portion; and,
wherein said gap is configured to hold the integrated hanging feature when said feature is in a retracted position, or to hold a portion of the integrated hanging feature when said feature is in an extended or partially extended position.

2. The integrated hanger case according to claim 1, wherein the rear panel comprises at least one opening usable for the operation of the mobile device when said mobile device is installed in the case portion.

3. The integrated hanger case according to claim 2, wherein the side wall comprises at least one opening and at least one button feature usable for the operation of the mobile device when said mobile device is installed in the case portion.

4. The integrated hanger case according to claim 3, wherein the rear panel comprises a pivot pin.

5. The integrated hanger case according to claim 4, wherein the integrated hanging feature is attached to the pivot pin and rotates around said pivot pin.

6. The integrated hanger case according to claim 5, wherein the case portion comprises an opening between a portion of the side wall and the rear panel and wherein the opening facilitates the rotation of the integrated hanging feature to a position in which said integrated hanging feature is partially outside the case portion.

7. The integrated hanger case according to claim 6, wherein the integrated hanging feature is fully retracted and is positioned inside the case portion.

8. The integrated hanger case according to claim 6, wherein the integrated hanging feature rotates to an extended position, and wherein in said position the hook is outside the case portion, enabling a user to hang the integrated hanger case.

9. The integrated hanger case according to claim 3, wherein the case portion comprises an opening between a portion of the side wall and the rear panel and wherein the opening facilitates sliding the integrated hanging feature into a position in which said integrated hanging feature is partially outside the case portion.

10. The integrated hanger case according to claim 9, wherein the rear panel comprises an opening used to contact the integrated hanging feature and slide said integrated hanging feature to a position in which said integrated hanging feature is partially outside the case portion.

11. The integrated hanger case according to claim 10, wherein the integrated hanging feature comprises an edge, wherein said edge is thicker than the opening between a portion of the side wall and the rear panel, thus preventing the integrated hanging feature from detaching from the case portion.

12. The integrated hanger case according to claim 11, wherein the integrated hanging feature is fully retracted and is positioned inside the case portion.

13. The integrated hanger case according to claim 11, wherein the integrated hanging feature slides to an extended position wherein the hook is outside the case portion, enabling a user to hang the integrated hanger case.
